(19) United States
(12) Patent Application Publication
(10) Pub. No.: US 2026/0203648 A1
(43) Pub. Date: Jul. 16, 2026

(54) INTELLIGENT MACHINE-LEARNED MODEL MONITORING

(71) Applicant: State Farm Mutual Automobile Insurance Company, Bloomington, IL (US)

(72) Inventors: Reuven Birnbaum, Dunwoody, GA (US); Ryan Washko, Bloomington, IL (US); Patrick Conway, Normal, IL (US); James J. Petersen, Heyworth, IL (US); Carlos A. Ramirez Villamarin, New York, NY (US)

(21) Appl. No.: 19/021,797

(22) Filed: Jan. 15, 2025

(51) Int. Cl. G06N 20/00

(52) U.S. Cl. CPC G06N 20/00

(57) ABSTRACT

Described herein are systems and techniques to infer the accuracy and variability of third-party machine-learned models based on input and output data. A baseline dataset may be used as input data to a model multiple times, and the resulting output data is compared to determine whether any significant differences are observed. A dataset having available ground truth data may be used as input data to a model and the resulting output data compared to the ground truth data to determine model accuracy. Input data metadata and output data metadata may be analyzed to determine changes over time that may indicate model and/or data source changes. Responsive actions may be taken, such as switching models, retraining downstream models, and/or suspending systems affected by adverse model changes.

### BACKGROUND

As artificial intelligence and machine-learning technologies have progressed, costs have come down. This has resulted in increased use of machine-learned models and artificial intelligence technologies across many industries and business sectors. Service providers offer access to machine learning model services to organizations and other customers as a simpler and more cost-effective alternative to owning, training, and maintaining models. However, the use of third-party models reduces the visibility into the training and configuration of such models. This may result in unpredictable and/or undesirable changes in the output of such models. It may be challenging to determine, from a service consumer perspective, whether and how a machine-learned model has changed, especially compared to any changes that may occur in the data being provided to the model for processing. The examples of the present disclosure are directed to overcoming these and other machine-learned model adjustment detection deficiencies and providing an automated system for detecting changes in machine-learned models and the data processed thereby and for taking responsive action to address such changes.

### SUMMARY

Techniques described herein implement an intelligent machine-learned model monitoring system that facilitates the monitoring of third-party machine-learned models and the inference of model variability and accuracy based on input and output data without requiring visibility to model configuration or training. The intelligent machine-learned model monitoring system may determine model variability based on analysis of output data generated by the model compared to previous output data generated using a baseline input dataset. Alternatively or additionally, the system may compare output data to ground truth data to determine accuracy. The system may also, or instead, analyze metadata associated with input data and/or output data to determine variability in data sources and/or model operations. Various operations may be performed in response to detected model inaccuracy or variability, including changing models for production data processing, retraining downstream model-based systems, and generating alerts for administrative users.

For example, the techniques described herein may relate to a computer-implemented method for inferring third-party machine-learned model performance, the computer-implemented method comprising transmitting, by a processor at a first time, first unstructured input data to a third-party machine-learned model; receiving, at the processor from the third-party machine-learned model, first labeled output data associated with the first unstructured input data; transmitting, by the processor at a second time subsequent to the first time, the first unstructured input data to the third-party machine-learned model; receiving, at the processor from the third-party machine-learned model, second labeled output data associated with the first unstructured input data; determining, at the processor, based on first labels represented in the first labeled output data and second labels represented in the second labeled output data, a difference value indicating a difference between the first labeled output data and the second labeled output data; determining, at the processor, that the difference value meets or exceeds a difference threshold; and initiating, at the processor, based on determining that the difference value meets or exceeds a difference threshold, one or more responsive actions.

In examples, the one or more responsive actions may include transmitting one or more instructions to train, based on the difference between the first labeled output data and the second labeled output data, a downstream machine-learned model configured to consume output generated by the third-party machine-learned model. The one or more responsive actions may also, or instead, include generating an interface on a user computing device comprising a display element indicating the difference value. The one or more responsive actions may also, or instead, include transmitting one or more instructions to a computing system configured to consume output generated by the third-party machine-learned model to terminate processing of production data using the third-party machine-learned model. In examples, the difference value is a first difference value, the third-party machine-learned model is a first third-party machine-learned model, and the one or more responsive actions comprise determining a second difference value for a second third-party machine-learned model; determining that the first difference value is less than or equal to the second difference value; and in response to determining that the first difference value is less than or equal to the second difference value, processing production data using the first third-party machine-learned model. In examples, the difference value is a first difference value, the third-party machine-learned model is a first third-party machine-learned model, and the one or more responsive actions comprise determining a second difference value for a second third-party machine-learned model; determining that the first difference value is greater than the second difference value; and in response to determining that the first difference value is greater than the second difference value terminating processing of production data using the second third-party machine-learned model; and initiating processing of the production data using the second third-party machine-learned model.

In further examples, the techniques described herein may relate to a non-transitory computer-readable medium comprising instructions that, when executed by one or more processors, cause the one or more processors to infer third-party machine-learned model performance by performing operations comprising transmitting first unstructured input data to a third-party machine-learned model; receiving, from the third-party machine-learned model, first labeled output data associated with the first unstructured input data; determining, based on first labels represented in the first labeled output data and second labels represented in ground truth data associated with the first unstructured input data, a difference value indicating a difference between the first labeled output data and the ground truth data; determining that the difference value meets or exceeds a difference threshold; and initiating, based on determining that the difference value meets or exceeds a difference threshold, one or more responsive actions.

In examples, the difference value is a first difference value, the third-party machine-learned model is a first third-party machine-learned model, and the one or more responsive actions comprise determining a second difference value for a second third-party machine-learned model; determining that the second difference value is less than the first difference value; and in response to determining that the second difference value is less than the first difference value terminating processing of production data using the second third-party machine-learned model; and initiating processing of the production data using the second third-party machine-learned model. The one or more responsive actions may include generating an interface on a user computing device comprising a display element indicating the difference value. The one or more responsive actions may also, or instead, include activating one or more of a haptic feedback device or vibrating mechanism as a user computing device. The one or more responsive actions may also, or instead, include transmitting one or more instructions to a computing system configured to consume output generated by the third-party machine-learned model to terminate processing of production data using the third-party machine-learned model. In examples, the difference value is a first difference value, the third-party machine-learned model is a first third-party machine-learned model, and the one or more responsive actions comprise determining a second difference value for a second third-party machine-learned model; determining that the first difference value is less than or equal to the second difference value; and in response to determining that the first difference value is less than or equal to the second difference value, processing production data using the first third-party machine-learned model. The one or more responsive actions may also, or instead, include transmitting an email notification comprising the difference value, transmitting a text message notification comprising the difference value, or transmitting a voice message notification comprising the difference value. The one or more responsive actions may also, or instead, include transmitting one or more instructions to train, based on the difference between the first labeled output data and the ground truth data, a downstream machine-learned model configured to consume output generated by the third-party machine-learned model.

In further examples, the techniques described herein may relate to a system for inferring third-party machine-learned model performance, the system comprising one or more processors; and a non-transitory memory storing computer-executable instructions that, when executed, cause the one or more processors to perform operations comprising determining first metadata for first unstructured input data received, at a first time, for processing at a third-party machine-learned model; determining second metadata for second unstructured input data received, at a second time subsequent to the first time, for processing at the third-party machine-learned model; determining, based on first metadata and the second metadata, a difference value indicating a difference between the first metadata and the second metadata; determining that the difference value meets or exceeds a difference threshold; and initiating, based on determining that the difference value meets or exceeds a difference threshold, one or more responsive actions.

In examples, the one or more responsive actions may include transmitting one or more instructions to train, based on the difference between the first metadata and the second metadata, a downstream machine-learned model configured to consume output generated by the third-party machine-learned model. The one or more responsive actions may also, or instead, include at least one of transmitting an email notification comprising the difference value, transmitting a text message notification comprising the difference value, or transmitting a voice message notification comprising the difference value. In examples, the difference between the first metadata and the second metadata may include a difference of one or more of file resolution, file type, file size, or location. The one or more responsive actions may also, or instead, include generating an interface on a user computing device comprising a display element indicating the difference value.

In further examples, the techniques described herein may relate to a system for inferring third-party machine-learned model performance, the system comprising means for transmitting first unstructured input data to a third-party machine-learned model; means for receiving, from the third-party machine-learned model, first labeled output data associated with the first unstructured input data; means for determining, based on first labels represented in the first labeled output data and second labels represented in ground truth data associated with the first unstructured input data, a difference value indicating a difference between the first labeled output data and the ground truth data; means for determining that the difference value meets or exceeds a difference threshold; and means for initiating, based on determining that the difference value meets or exceeds a difference threshold, one or more responsive actions.

### BRIEF DESCRIPTION OF THE DRAWINGS

FIG. 1 illustrates an example environment in which intelligent machine-learned model monitoring systems and methods may be implemented.

FIG. 2 is a flow diagram illustrating an example process for determining changes in a third-party machine-learned model according to the examples of intelligent machine-learned model monitoring systems and methods described herein.

FIG. 3 is a flow diagram illustrating another example process for determining changes in a third-party machine-learned model according to the examples of intelligent machine-learned model monitoring systems and methods described herein.

FIG. 4 is a flow diagram illustrating an example process for determining changes in third-party machine-learned model input data according to the examples of intelligent machine-learned model monitoring systems and methods described herein.

FIG. 5 is a flow diagram illustrating an example process for determining changes in third-party machine-learned model output data according to the examples of intelligent machine-learned model monitoring systems and methods described herein.

FIG. 6 is a flow diagram illustrating an example process for determining and implementing actions in response to determined changes in third-party machine-learned models according to the examples of intelligent machine-learned model monitoring systems and methods described herein.

FIG. 7 shows an example system architecture for a computing device that may be used to implement the intelligent machine-learned model monitoring systems and methods described herein.

The detailed description is set forth with reference to the accompanying figures. In the figures, the left-most digit(s) of a reference number identifies the figure in which the reference number first appears. The use of the same reference numbers in different figures indicates similar or identical items.

### DETAILED DESCRIPTION

Certain implementations and examples of the disclosure will now be described more fully below with reference to the accompanying figures, in which various aspects are shown. However, the various aspects may be implemented in many different forms and should not be construed as limited to the implementations set forth herein. The disclosure encompasses variations of the examples, as described herein. Like numbers refer to like elements throughout.

Many systems incorporate the use of third-party models and other data processing systems. While this may be more cost-effective than training and maintaining models and data processing systems locally (e.g., by the organizations operating such systems), providers of third-party models and systems may not allow sufficient visibility into the training and configuration of such models and systems. This may result in unpredictable and/or undesirable changes in the output of such models and systems. Because of this lack of visibility to the configurations, training, and other aspects of these third-party models and systems, such systems and models may be referred to herein as “obscured” systems or models.

It may be challenging to determine, from a data processing service consumer perspective, whether and how a model or system has changed over time, especially compared to any changes that may occur in the data being provided to the model or system for processing. The examples of the present disclosure are directed to overcoming these and other model and system adjustment detection deficiencies and providing an automated system for detecting changes in model or system and the data processed thereby and for taking responsive action to address such changes. While a machine-learned model, or simply “model,” may be used in the examples set forth herein, the disclosed systems and techniques are applicable to any remote, obscured, and/or third-party system that accepts input and provides output and that may not provide information regarding changes to that system and/or the data input and/or output to user of the system.

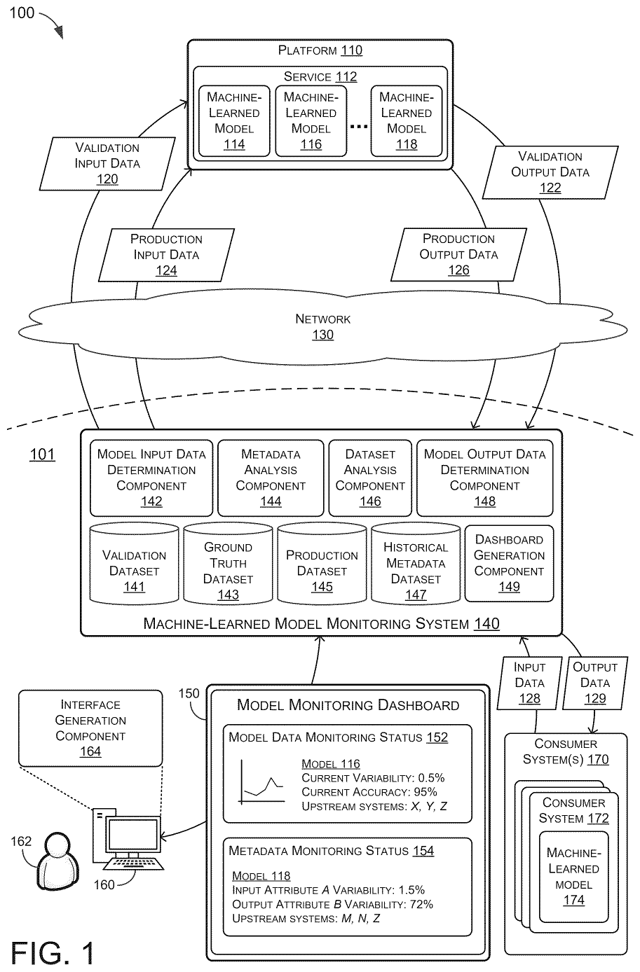

FIG. 1 illustrates an environment 100 in which an intelligent machine-learned model monitoring system may be implemented according to examples of the instant disclosure. A platform 110 may provide one or more of any type of computing services or applications to organizations and other customers, including machine-learned model-based services such as service 112. The platform 110 may be, or may be configured within, an environment configured to provide these one or more computing resources implemented as, for example, one or more physical servers and/or other hardware located at one or more particular geographical locations. The platform 110 may include resources implemented on physical devices and/or systems located in a single geographical location or distributed across multiple geographical locations. In particular examples, the platform 110 may be a cloud-based computing resource provider. The platform 110 may provide computing resources including, without limitation, data storage resources, data processing resources (e.g., virtual machine (VM) instances), networking resources, data communication resources, network services, and/or other types of computing services and/or resources.

The service 112 implemented at the platform 110 may provide one or more services that may be based on one or more machine-learned models. For example, the service 112 may offer machine-learned model-based services that may include the execution and/or use of one or more of machine-learned models 114, 116, and 118. The service 112 may include any number and any type of machine-learned model. Furthermore, the platform 110 may include any number of services, including other services involving the use of one or more machine-learned models of any type.

An organization 101 may be a user, customer, and/or consumer of one or more machine-learned model-based services offered by the service 112 (referred to generally herein as “service 112”). For example, the organization 101 may use the service 112 to process unstructured data, such as images, audio, video, text, documents, etc. to categorize, label, identify, and/or otherwise determine attributes of the content of such data. For instance, the organization 101 may use the service 112 to determine the types of objects represented in images provided by its users (e.g., car, truck, person, house, tree, etc.). In another example, the organization 101 may use the service 112 to determine the type of content of represented in documents provided by its users (e.g., name, address, telephone number, etc.).

The service 112 may allow its users (e.g., organization 101) to request specific models for use in the provided service(s). For example, the service 112 may receive instructions from the organization 101 to use a particular one of the machine-learned models 114, 116, and 118 for unstructured data processing. Alternatively or additionally, the platform 110 may separate the use of particular models into distinct services. For example, each of the machine-learned models 114, 116, and 118 may be utilized with a distinct service that may be requested or otherwise engaged by a user such as the organization 101.

The organization 101 may communicate electronically with the platform 110 via a network 130. The network 130 may facilitate communications between any of the resources of the platforms 110 and any of the devices and/or systems associated with the organization 101. The network 130 represents any number, type, and combination of wireless and/or wired networks that may be configured to facilitate communications between computing devices and/or systems. The network 130 may represent any communications means (e.g., any physical and/or logical communications connections) that allow components, systems, services, and/or devices of any type (e.g., physical and/or virtual) to interact with each other user. In examples, such interactions may be facilitated by application programming interfaces (APIs) configured at such components, etc.

The organization 101 may implement a machine-learned model monitoring system 140 to perform one or more of the intelligent machine-learned model monitoring operations described herein. Through the use of the disclosed techniques, the machine-learned model monitoring system 140 may be configured to infer performance properties, such as variability and accuracy, of third-party or obscured models and model systems. The machine-learned model monitoring system 140 may include a model input data determination component 142, a metadata analysis component 144, a dataset analysis component 146, and a model output data determination component 148 that may be configured to perform various model monitoring operations, such as those described in more detail herein. The machine-learned model monitoring system 140 may further include a dashboard generation component 149 that may generate data and instructions that may be used to generate a monitoring dashboard on a user computing device, as described in more detail herein. The machine-learned model monitoring system 140 may further include, or include components to access, a validation dataset 141, a ground truth dataset 143, a production dataset 145, and/or a historical metadata dataset 147. Each of these datasets 141, 143, 145, and 147 may be stored at one or more databases and/or other data storage systems locally implemented by the machine-learned model monitoring system 140 and/or remotely accessed by one or more components of the machine-learned model monitoring system 140.

In examples, the machine-learned model monitoring system 140 may perform one or more operations to determine whether the model used in a service engaged by the organization 101 has been changed. The platform 110 and/or the operator thereof may retrain and/or reconfigure one or more of the machine-learned models 114, 116, and 118 and/or the service 112 executing such models. This model and/or service update may not be visible to the organization 101 and/or the operator of the platform 110 may not provide notice of such changes to the organization 101. Therefore, the organization 101 may execute various operations using machine-learned model monitoring system 140 to determine whether the model used in a service engaged by the organization 101 has been changed.

For example, the machine-learned model monitoring system 140 may be configured to use known baseline or validation data to determine whether a model has changed over time. The validation dataset 141 may include one or more sets of data, such as unstructured data, that may be used periodically and/or in response to one or more conditions to detect changes in a model executed by a service engaged by the organization 101 to process such data. The validation dataset 141 may include validation input data 120 that may be maintained consistently over time so that it may be used for model change detection operations. The model input data determination component 142 may determine or otherwise acquire the validation input data 120 from the validation dataset 141 and provide, at a first time (“first validation data transmission time”) via the network 130, the validation input data 120 to the platform 110 (e.g., to an API at the service 112) with a request for processing by the service 112. The service 112 may process this data using, for example, the machine-learned model 114 to generate the validation output data 122.

The validation output data 122 (“first validation output data 122”) may be received via the network 130 at the machine-learned model monitoring system 140 (e.g., at an API at the machine-learned model monitoring system 140). The model output data determination component 148 of the machine-learned model monitoring system 140 may receive the validation output data 122 and store it at the validation dataset 141. In examples, the model output data determination component 148 may also store a timestamp and/or other identifying data indicating the time of receipt of the validation output data 122 (“first validation output data receipt time”).

At a later time (subsequent to the first validation data transmission time), the model input data determination component 142 may again determine or otherwise acquire the validation input data 120 from the validation dataset 141 and provide, at a second time (“second validation data transmission time”) via the network 130, the validation input data 120 to the platform 110 (e.g., to an API at the service 112) with a request for processing by the service 112 (e.g., a request to label objects in images and/or video, identify content in documents and/or audio files, etc.). The service 112 may process this data using, e.g., the machine-learned model 114 to generate a subsequent version of the validation output data 122 (“second validation output data 122”).

The second validation output data 122 may be received via the network 130, at the machine-learned model monitoring system 140 (e.g., at an API at the machine-learned model monitoring system 140), which may, using the model output data determination component 148, store it at the validation dataset 141 with a timestamp and/or other identifying data indicating the time of receipt of the subsequent validation output data 122 (“second validation output data receipt time”).

The machine-learned model monitoring system 140 may be configured to perform analysis that compares the first validation output data 122 and the second validation output data 122 to determine whether there have been any (e.g., significant) changes in how data is processed by the service 112 and, in this particular example, by the model 114, between the first validation output data receipt time and the second validation output data receipt time.

For example, the dataset analysis component 146 may analyze the output data the first validation output data 122 and the second validation output data 122 to determine if there are significant differences in these datasets. Because the validation input data 120 was the same data provided to the service 112 to generate each of the first validation output data 122 and the second validation output data 122, one or more significant differences between the first validation output data 122 and the second validation output data 122 may be due to model changes (e.g., retraining and/or reconfiguration of the model 114). To perform this comparison, the dataset analysis component 146 may compare labels, categorization, data attributes, and/or other characteristics of the output data.

In an illustrative non-limiting example, the validation input data 120 may include 100 images. If the first validation output data 122 indicates that 75 of those images include representations of cars (e.g., include a “car” label associated with 75 of the images) and the second validation output data 122 indicates that 76 of those images include representations of cars (e.g., include a “car” label associated with 76 of the images), the dataset analysis component 146 may determine that there has been no significant change in the model executed by the service 112. Alternatively, if the first validation output data 122 indicates that 75 of the input data images include representations of cars (e.g., include a “car” label associated with 75 of the images) and the second validation output data 122 indicates that 25 of those images include representations of cars (e.g., include a “car” label associated with 25 of the images), the dataset analysis component 146 may determine that there has been a significant change in the model executed by the service 112. In response, the machine-learned model monitoring system 140 may initiate one or more responsive actions, such as those described herein.

In examples, the machine-learned model monitoring system 140 may be configured to use validation data and associated ground truth data to determine whether a model has become more or less accurate over time. For example, the ground truth dataset 143 may include ground truth data associated with data (e.g., unstructured data) included in the validation dataset 141. The machine-learned model monitoring system 140 may use such validation data and associated ground truth data periodically and/or in response to one or more conditions to determine accuracy changes in a model executed by a service engaged by the organization 101 to process such data. In an example, the validation input data 120 may have associated ground truth data stored at the ground truth dataset 143.

In this example, the model input data determination component 142 may determine or otherwise acquire the validation input data 120 from the validation dataset 141 and provide the validation input data 120 to the platform 110 (e.g., to an API at the service 112) via the network 130 with a request for processing by the service 112 (e.g., a request to label objects in images and/or video, identify content in documents and/or audio files, etc.). The service 112 may process this data using, for example, the machine-learned model 114 to generate the validation output data 122.

The validation output data 122 may be received via the network 130 at the machine-learned model monitoring system 140 (e.g., at an API at the machine-learned model monitoring system 140). The model output data determination component 148 of the machine-learned model monitoring system 140 may receive the validation output data 122 and store it at the validation dataset 141. In examples, the model output data determination component 148 may also store a timestamp and/or other identifying data indicating the time of receipt of the validation output data 122.

The machine-learned model monitoring system 140 may be configured to perform analysis that compares the validation output data 122 and the associated ground truth data from the ground truth dataset 143 to determine an accuracy of the processing of the validation input data 120 by the service 112 and, in this particular example, by the model 114.

For example, the dataset analysis component 146 may analyze the validation output data 122 and the associated ground truth data to determine if there are significant differences in these datasets. To perform this comparison, the dataset analysis component 146 may compare labels, categorization, data attributes, and/or other characteristics of the validation output data 122 to corresponding characteristics of the ground truth data. A significant discrepancy between validation output data 122 and the associated ground truth data may indicate a loss of accuracy by the model executed by the service 112.

In an illustrative non-limiting example, the ground truth data associated with the validation input data 120 and the validation output data 122 may include 100 audio files. If the validation output data 122 indicates that 49 of the audio files contain the word “claim” (e.g., include a “claim” label associated with 49 of the audio files) and the ground truth data indicates that 50 of the audio files contain the word “claim” (e.g., include a “claim” label associated with 50 of the audio files) and that the 49 audio files with “claim” indicated by the validation output data 122 correspond to 49 of the 50 audio files in the ground truth data that include “claim,” the dataset analysis component 146 may determine that the model executed by the service 112 is relatively accurate.

Alternatively, if the validation output data 122 indicates that 19 of the audio files contain the word “claim” (e.g., include a “claim” label associated with 49 of the audio files) and the ground truth data indicates that 50 of the audio files contain the word “claim” (e.g., include a “claim” label associated with 50 of the audio files) the dataset analysis component 146 may determine that the model executed by the service 112 is relatively inaccurate.

In another example, if the validation output data 122 indicates that 50 of the audio files contain the word “claim” (e.g., include a “claim” label associated with 50 of the audio files) and the ground truth data indicates that 50 of the audio files contain the word “claim” (e.g., include a “claim” label associated with 50 of the audio files), but the 50 audio files with “claim” indicated by the validation output data 122 do not substantially correspond to the 50 audio files in the ground truth data that include “claim,” the dataset analysis component 146 may determine that the model executed by the service 112 is relatively inaccurate. In response to a determination of significant model inaccuracy, the machine-learned model monitoring system 140 may initiate one or more responsive actions, such as those described herein.

In examples, the machine-learned model monitoring system 140 may also, or instead, determine changes to metadata of input data and/or output data to determine changes in model configuration and/or performance. For example, the machine-learned model monitoring system 140 may access or determine production data from production dataset 145. Production data may be data received for processing (e.g., by the service 112) in a production context (e.g., as part of normal business, normal operations, etc., as opposed to test data, validation data, ground truth data, etc.). The machine-learned model monitoring system 140 may determine and store metadata for production data (input and/or output data) at the historical metadata dataset 147. This metadata may be analyzed to determine changes in the input provided to models and/or changes in the output received from models.

For example, the machine-learned model monitoring system 140 may be configured to receive or otherwise determine input data 128 that may be received from one or more consumer systems 170. The consumer system(s) 170 may be any one or more business systems, devices, organizations, etc., that may interact with the service 112 in order to perform production functions. The consumer system(s) 170 may be the source of input data for the service 112 and/or the recipient of output data generated by the service 112. In examples, the consumer system(s) 170 may include and/or execute one or more machine-learned models that may be used to generate input data that may be provided to the service 112. The consumer system(s) 170 may also, or instead, include and/or execute one or more machine-learned models that may be used to process output data generated by the service 112. For example, the consumer system 172 may execute or otherwise interact with a machine-learned model 174 that may be configured to generate input data intended for the service 112 and/or process output data generated by the service 112.

In examples, the consumer system 172 may generate input data 128 at a first time (“first input data 128”) that may be provided to the machine-learned model monitoring system 140. The machine-learned model monitoring system 140 (e.g., the model input data determination component 142) may generate production input data 124 (“first production input data 124”) based on the input data 128. The model input data determination component 142 may also determine the metadata associated with the first input data 128 and/or the first production input data 124 and associate that metadata with the first production input data 124 at the historical metadata dataset 147.

The machine-learned model monitoring system 140 (e.g., the model input data determination component 142) may provide the first production input data 124 to the platform 110 (e.g., to an API at the service 112) via the network 130 with a request for processing by the service 112 (e.g., a request to label objects in images and/or video, identify content in documents and/or audio files, etc.). The service 112 may process this data using, for example, the machine-learned model 114 to generate the production output data 126 (“first production output data 126”). The first production output data 126 may be received via the network 130 at the machine-learned model monitoring system 140 (e.g., at an API at the machine-learned model monitoring system 140).

The machine-learned model monitoring system 140 (e.g., the model output data determination component 148) may generate output data 129 (“first output data 129”) based on the first production output data 126. The model output data determination component 148 may also determine the metadata associated with the first output data 129 and/or the first production output data 126 and associate that metadata with the first production output data 124 at the historical metadata dataset 147. The machine-learned model monitoring system 140 may then transmit the first output data 129 to the consumer system 172.

The consumer system 172 may generate subsequent input data 128 at a second, later time (“second input data 128”) that may be similarly processed to generate second production input data 124 that may be provided to the service 112 to generate second production output data 126. The machine-learned model monitoring system 140 (e.g., the model output data determination component 148) may generate second output data 129 based on this second production output data 126 and provide the second output data 129 to the consumer system 172. The model input data determination component 142 may determine metadata associated with the second input data 128 and/or the second production input data 124 and store such metadata at the historical metadata dataset 147, associating such metadata with the second production input data 124. Similarly, the model output data determination component 148 may determine metadata associated with the second output data 129 and/or the second production output data 126 and store such metadata at the historical metadata dataset 147, associating such metadata with the second production output data 126.

The machine-learned model monitoring system 140 may be configured to perform analysis that compares the metadata of input data received and/or determined at various times to determine whether there have been any (e.g., significant) changes in input metadata. The machine-learned model monitoring system 140 may also, or instead, be configured to perform analysis that compares the metadata of output data received and/or determined at various times to determine whether there have been any (e.g., significant) changes in output metadata. Significant changes in input data metadata may indicate a significant change in the sources of such data, which may affect, among other things, a choice of model and/or service for processing such data. Significant changes in output data metadata may indicate a significant change in the model and/or service that generated such output data, which may affect, among other things, the downstream processing of such output data.

For example, the metadata analysis component 144 may analyze the metadata associated with the first production input data 124 and the metadata associated with the second production input data 124 to determine if there are significant differences in the metadata. To perform this comparison, the metadata analysis component 144 may compare metadata such as file type, file size, resolution, location (e.g., GPS coordinates), duration (e.g., length of an audio or video file), data capture device type and/or identifier, etc. Note that metadata generated using additional processing may also be compared, such as file source, associated business organization, etc. Significant differences between the metadata associated with the first production input data 124 and the metadata associated with the second production input data 124 may be due to changes in the sources of such data and/or other changes that may affect downstream processing and business decisions. For example, shifts in the amount of data received from various geographical locations may indicate a shift in users providing such data that may warrant further investigation.

In an illustrative non-limiting example, the metadata associated with the first production input data 124 may indicate that 75% of the images in the first production input data 124 are .jpeg images, and the metadata associated with the second production input data 124 may indicate that 78% of the images in the second production input data 124 are .jpeg images. This may not indicate a significant change. On the other hand, if the metadata associated with the first production input data 124 indicates that 75% of the images in the first production input data 124 are .jpeg images and the metadata associated with the second production input data 124 may indicate that 25% of the images in the second production input data 124 are .jpeg images, this may indicate a significant change in input data. In response, the machine-learned model monitoring system 140 may initiate one or more responsive actions, such as those described herein.

In another illustrative non-limiting example, the metadata associated with the first production output data 126 may indicate that 65% of the audio files in the first production output data 126 are 30 seconds or less, and the metadata associated with the second production output data 126 may indicate that 60% of the audio files in the second production output data 126 are 30 seconds or less. This may not indicate a significant change. On the other hand, if the metadata associated with the first production output data 126 may indicate that 65% of the audio files in the first production output data 126 are 30 seconds or less, and the metadata associated with the second production output data 126 may indicate that 10% of the audio files in the second production output data 126 are 30 seconds or less, this may indicate a significant change in output data. In response, the machine-learned model monitoring system 140 may initiate one or more responsive actions, such as those described herein.

One or more responsive actions may be implemented based on any of these determined model, data, and/or metadata factors. In examples, a notification and/or monitoring information may be provided to a user, for example on a dashboard interface generated at a user computing device. The machine-learned model monitoring system 140 may also, or instead, include a dashboard generation component 149 that may be configured to interact with one or more user devices to generate and/or present a machine-learned model monitoring dashboard interface, such as a model monitoring dashboard interface 150. For example, the dashboard generation component 149 may receive, obtain, generate, and/or determine data associated with one or more model monitoring operations and/or activities performed as described herein. The dashboard generation component 149 may receive a request for such data and/or may otherwise determine to provide such data to an interface generation component of a user device, such as interface generation component 164 configured at device 160 operated by a user 162. The interface generation component 164 may then use such data to generate and present (e.g., on a device display) a model monitoring dashboard interface, such as the model monitoring dashboard interface 150, that may allow a user to interact with, execute, initiate, or otherwise manipulate model monitoring operations and data via interface elements presented on the model monitoring dashboard interface 150.

The interface generation component 164 configured at user device 160 may be an application and/or service that is configured to communicate with the machine-learned model monitoring system 140 and to generate and/or present interfaces on the user device 160. In some examples, the interface generation component 164 may be a browser application. The interface generation component 164 may have associated states and data that may be used in the generation of a navigation interface as described herein.

The model monitoring dashboard interface 150 represents an exemplary interface and data that may be associated therewith. The model monitoring dashboard interface 150 includes model data monitoring status 152 that may be a display element presenting data, such as a significant change or discrepancy in model input and/or output data determined as described herein. The model monitoring dashboard interface 150 may further include metadata monitoring status 154 that may be a display element presenting data, such as a significant change or discrepancy in metadata associated with input and/or output data determined as described herein. In response to any one or more of the changes and/or discrepancies determined as described herein, the dashboard generation component 149 may generate and/or update the model monitoring dashboard interface 150 to indicate the associated data and/or may generate display data and/or controls that may be based on determined changes and/or discrepancies. The dashboard generation component 149 may further determine one or more trends over time of any of the accuracy and/or discrepancy data determined as described herein and generate a display element for presentation on the model monitoring dashboard interface 150 illustrating this trend.

Other responsive actions may also be performed in response to any one or more of the changes and/or discrepancies determined as described herein. In examples, the machine-learned model monitoring system 140 may track the accuracy and/or variability of multiple models. For example, the machine-learned model monitoring system 140 may store model accuracy data for each of the models 114, 116, and 118 based on ground truth discrepancies determined as described herein. Based on such data, the machine-learned model monitoring system 140 may reconfigure automatically one or more associated data processing systems. For example, the machine-learned model monitoring system 140 may select the most accurate model to use or request from the service 112 (and/or select a service that uses a more accurate model) for processing production data. This selection may be performed periodically and/or in response to one or more conditions. The machine-learned model monitoring system 140 may then reconfigure an associated system, such as the consumer system 172, to use a different model (e.g., use machine-learned model 116 instead of machine-learned model 114). In examples, the machine-learned model monitoring system 140 may also, or instead, generate and send an instruction to such a system, to use a different model for processing production data.

Similarly, the machine-learned model monitoring system 140 may store model variability data for each of the models 114, 116, and 118 based on the model variability determined using validation data determined as described herein. Based on such data, the machine-learned model monitoring system 140 may select the least variable model (e.g., over a period of time) to use or request from the service 112 (and/or select a service that uses a more accurate model) for processing production data. This selection may also be performed periodically and/or in response to one or more conditions. The machine-learned model monitoring system 140 may then reconfigure an associated system, such as the consumer system 172, to use a different model (e.g., use machine-learned model 116 instead of machine-learned model 114). In examples, the machine-learned model monitoring system 140 may also, or instead, generate and send an instruction to such a system, to use a different model for processing production data.

Downstream processes may also be adjusted based on the determined model accuracy and/or variability data. For example, the machine-learned model monitoring system 140 may suspend or terminate one or more downstream processes or operations based on determining that a model or service in use is sufficiently inaccurate or variable. For instance, the machine-learned model monitoring system 140 may send one or more instructions to one or more of the consumer system(s) 170 that may instruct such system(s) to terminate or suspend activities that may rely on output data generated by a model or service determined to be overly variable and/or inaccurate.

Alternatively or additionally, the machine-learned model monitoring system 140 may retrain or otherwise update one or more downstream machine-learned models that use, directly or indirectly, output data generated by a model or service determined to be overly variable and/or inaccurate. For instance, the machine-learned model monitoring system 140 may send one or more instructions to one or more of the consumer system(s) 170 that may instruct such system(s) to train one or more models supported by such system(s) (e.g., machine-learned model 174) to account for a determined change in an upstream model or service (e.g., service 112 and/or one or more of the models 114, 116, and 118). For example, the system may cause a downstream model to be retrained with higher resolution image files when the input data to an upstream model and/or the output data generated by the upstream model is determined to be higher resolution than previously experienced (e.g., based on metadata analysis).

Alternatively or additionally, the machine-learned model monitoring system 140 may modify or implement one or more business processes based on variability and/or accuracy determinations performed as described herein. For instance, the machine-learned model monitoring system 140 may generate or modify a workflow associated with one or more users or workgroups to include one or more actions related to addressing the determined variability and/or accuracy issues. Data representing this modified workflow may be presented on an interface such as the model monitoring dashboard interface 150. Other action notifications and/or presentations may be used, such as sending a text message, generating a voice message, and generating a vibrating notification or other haptic feedback at a user computing device (e.g., a smartphone operated by a user of the machine-learned model monitoring system 140, such as the user 162).

By facilitating the intelligent monitoring of third-party and other obscured machine-learned models and model-based services, the systems and techniques described herein facilitate the faster and more efficient adjustment of the operations that may be required to accommodate model and/or service changes that may otherwise not have been detected. The use of automated model monitoring resources to perform model, service, data, and metadata accuracy and variability determinations ensures that the appropriate adjustments are more quickly put in place so that production operations may be minimally impacted. Moreover, using the machine-learned model monitoring systems and techniques described herein may improve the performance of associated systems and operations by reducing or eliminating the need for repeatedly performing operations in response to receiving unexpected results that were generated based on inaccurate or variable models and services. The disclosed systems and techniques further reduce the need to manually inspect data to determine model and service variability and accuracy. The disclosed systems and techniques provide a faster and more efficient way to determine model and service variability and accuracy compared to traditional techniques of manually collecting and processing model-related data.

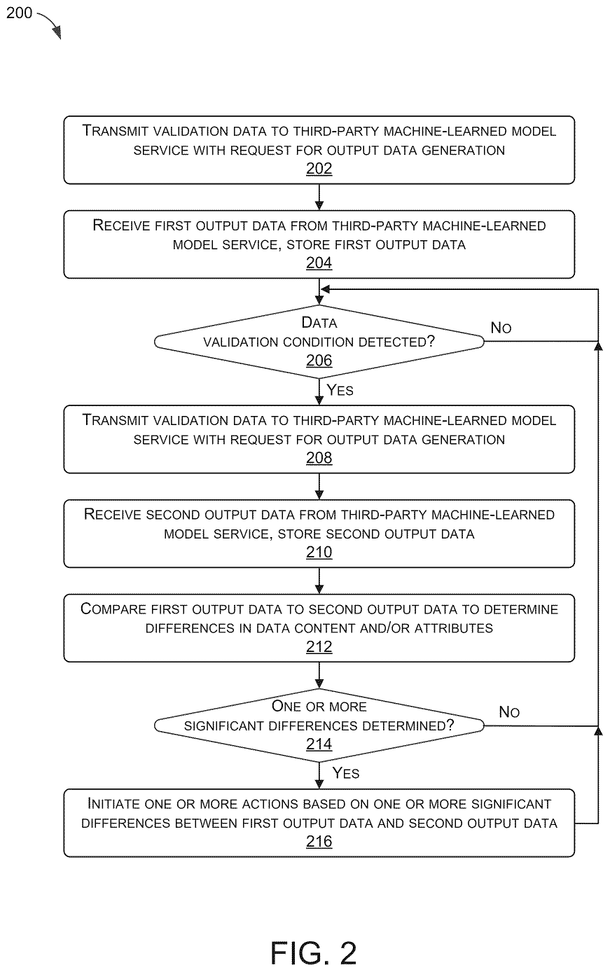

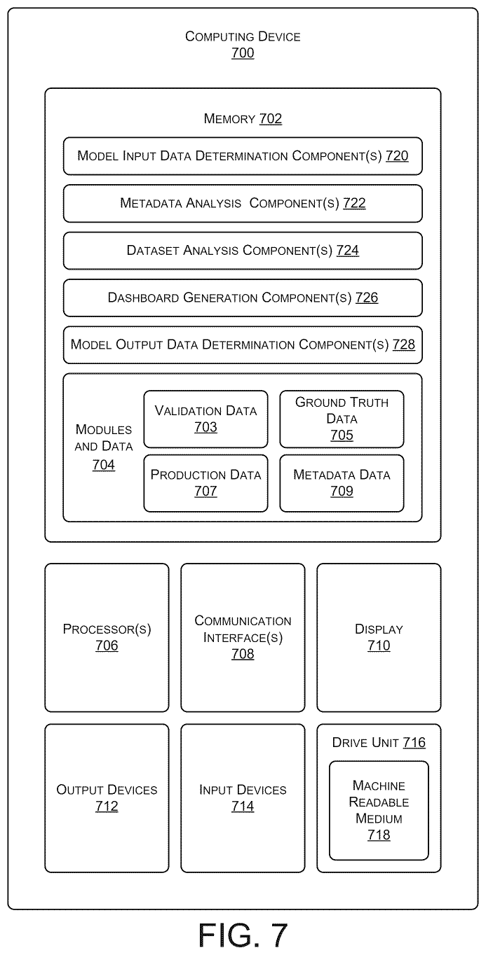

FIG. 2 is a flow diagram of an example process 200 for determining model and/or system variability in an intelligent machine-learned model monitoring system. In examples, one or more operations of the process 200 may be implemented by a machine-learned model monitoring system, such as by using one or more of the components and systems illustrated in FIG. 1. In examples, one or more operations of the process 200 may be implemented by the machine-learned model monitoring system 140 illustrated in FIG. 1. One or more operations of the process 200 may also, or instead, by implemented by one or more of the components and systems associated with the computing device 700 illustrated in FIG. 7. In other examples, one or more operations of the process 200 may be performed by a combination of components described in regard to these systems and/or other systems. However, the process 200 is not limited to being performed by such components and systems, and the components and systems described herein are not limited to performing the operations of the process 200.

At block 202, validation data may be sent to a machine-learned model service with a request for output data generation. For example, unstructured input data (e.g., images, video, audio, documents, etc.) may be sent to a cloud-based service provider that executes a machine-learned model to determine output indicating labels, categorizations, classification, etc., that may identify objects, features, and/or other content represented by such unstructured data. The unstructured data may be provided to the model service along with instructions requesting particular output, such as labels, categorizations, classification, etc. The unstructured data and request instructions may be provided to the service provider via an API configured at the model service.

At block 204, the output data generated by the model executed at the model service may be received and stored. In the example of FIG. 2, this output data will be referred to as “first validation output data.” This first validation output data may include the model-generated labels, categorizations, classification, etc. The first validation output data may or may not include the input data and/or one or more references to the input data that may indicate an association with the input unstructured data and the model-generated labels, categorizations, classification, etc. The first validation output data may be stored at a validation dataset or data store as described herein. The system may also generate a timestamp and/or other indication of a time of receipt of this first validation output data. Alternatively or additionally, the system may generate a timestamp and/or other indication of a time of transmission of the validation data that was provided to the model service to generate the first validation output data.

At block 206, the system may determine whether a validation condition has occurred or been detected. For example, the system may be configured to perform one or more model variability determinations periodically (e.g., hourly, daily, weekly, etc.). Alternatively or additionally, the system may be configured to perform one or more model variability determinations based on receiving an instruction from a user or other system. Alternatively or additionally, the system may be configured to perform one or more model variability determinations based on detecting one or more other systemic conditions, such as detecting a threshold amount of input data sent to a model service and/or detecting receipt of a threshold amount of output data from the model service. Any other conditions may be detected and evaluated at block 206.

If no data validation condition is detected at block 206, the system may return to block 206 until such a condition is detected.

If, at block 206, a data validation condition is detected, at block 208, the (e.g., same) validation data may again be sent to the machine-learned model service with a request for output data generation. As noted above, this validation data may be unstructured input data and may be provided (e.g., via an API configured at the model service) with instructions requesting the same types of particular output as requested in the generation of the first validation output data.

At block 210, the output data generated by the model executed at the model service in response to this subsequent transmission of the validation data may be received and stored. In the example of FIG. 2, this subsequent output data will be referred to as “second validation output data.” As with the first validation output data, this second validation output data may include the model-generated labels, categorizations, classification, etc., and may or may not include the input validation data and/or one or more references to the input data. This second validation output data may be stored at a validation dataset or data store as described herein. The system may also generate a timestamp and/or other indication of a time of receipt of the second validation output data. Alternatively or additionally, the system may generate a timestamp and/or other indication of a time of subsequent transmission of the validation data that was provided to the model service to generate the second validation output data.

At block 212, the system may compare the first validation output data to the second validation output data to determine if there are any differences. In examples, the system may determine if the labels, categorizations, classification, attributes, properties, etc. of the first validation output data differ from the corresponding labels, categorizations, classification, attributes, properties, etc. of the second validation output data. For example, the system may determine if labels associated with a same piece of validation data (e.g., image, audio file, video file, document, etc.) are not the same or at least substantially similar, the system may determine that there is a discrepancy between the first validation output data and the second validation output data. In examples, the system may determine a difference value or a discrepancy value that may represent the determined differences.

At block 214, the system may determine whether any determined discrepancies are significant. In examples, the system may use a difference threshold to determine significance. In a particular non-limiting example, the system may be configured to use a 25% difference threshold. In such an example, if there are 100 images with “car” labels in the first validation output data and 95 images with “car” labels in the second validation output data (e.g., a 5% difference value), the system may determine that this is not a significant discrepancy. However, if there are 100 images with “car” labels in the first validation output data and 65 images with “car” labels in the second validation output data (e.g., a 35% difference value), the system may determine that this is a significant discrepancy. As will be appreciated, any other thresholds and means of comparing two or more output datasets may be used and are contemplated as within the scope of the instant disclosure. Note that the system may store any determined differences or discrepancies (regardless of whether they reach a difference threshold) and associated data for other operations, such as trend determinations.

If no significant differences are determined at block 214, the system may return to block 206 for the next validation condition detection. In examples, the system may use one initial (first) set of validation output data as a baseline over a period of time, regularly comparing subsequent output data generated using the same validation input to determine model changes. Alternatively or additionally, the system may use the most recently determined validation output data as the baseline for a subsequent generation of output data using the same validation input to determine model changes. Any variation of these operations may also be used.

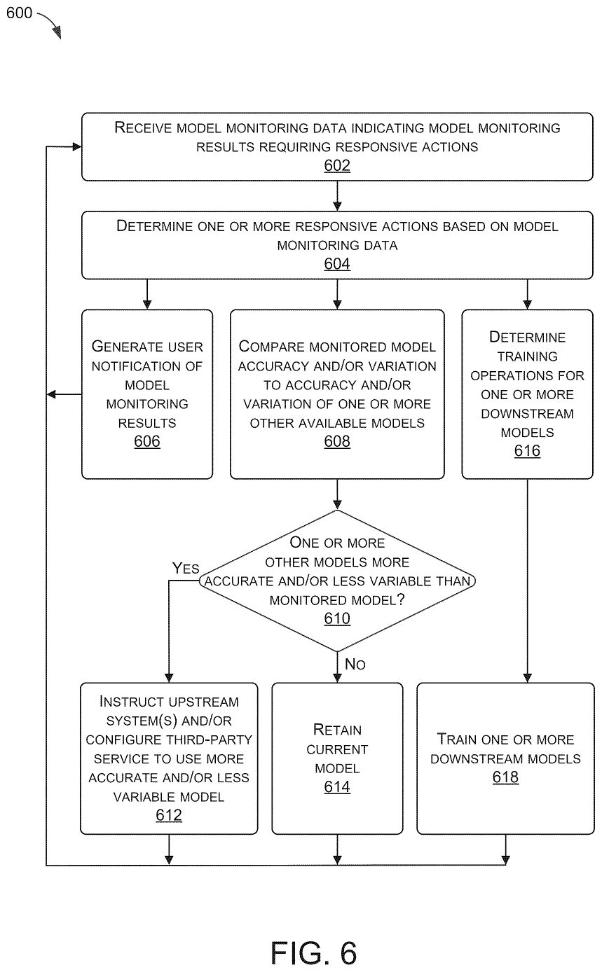

If there are significant differences determined at block 214, at block 216, the system may initiate one or more actions based on the determined differences. Examples of such actions are described in more detail herein, including above in regard to FIG. 1 and below in regard to FIG. 6. The process may also then return to block 206 for the next validation condition detection.

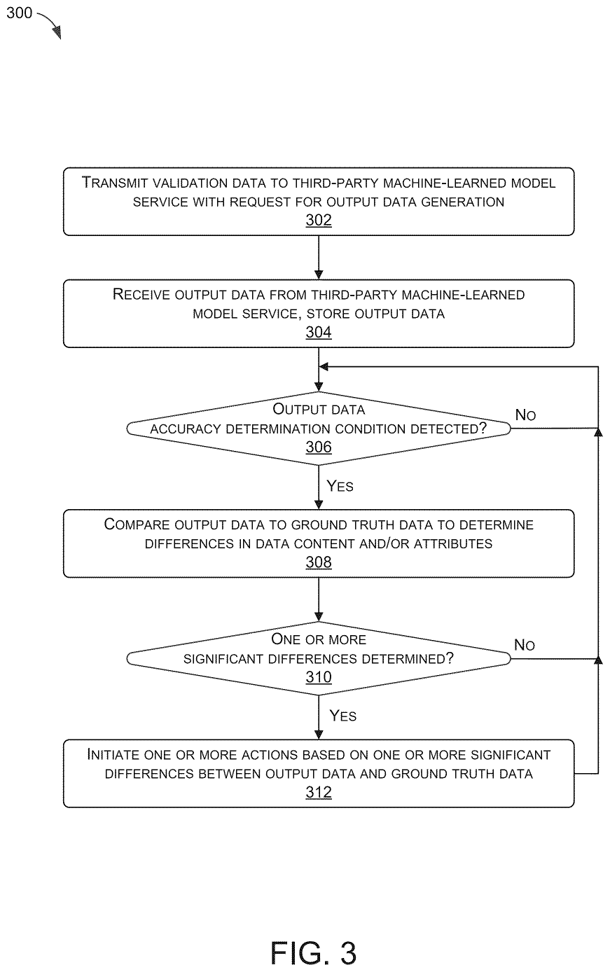

FIG. 3 is a flow diagram of an example process 300 for determining model and/or system accuracy in an intelligent machine-learned model monitoring system. In examples, one or more operations of the process 300 may be implemented by a machine-learned model monitoring system, such as by using one or more of the components and systems illustrated in FIG. 1. In examples, one or more operations of the process 300 may be implemented by the machine-learned model monitoring system 140 illustrated in FIG. 1. One or more operations of the process 300 may also, or instead, be implemented by one or more of the components and systems associated with the computing device 700 illustrated in FIG. 7. In other examples, one or more operations of the process 300 may be performed by a combination of components described in regard to these systems and/or other systems. However, the process 300 is not limited to being performed by such components and systems, and the components and systems described herein are not limited to performing the operations of the process 300.

At block 302, validation data may be sent to a machine-learned model service with a request for output data generation. For example, unstructured input data (e.g., images, video, audio, documents, etc.) may be sent to a cloud-based service provider that executes a machine-learned model to determine output indicating labels, categorizations, classification, etc. that indicate objects, features, and/or other content represented by such unstructured data. The unstructured data may be provided with instructions requesting particular output, such as the labels, categorizations, classification, etc. The unstructured data and request instructions may be provided to the service provider via an API configured at the model service. This particular validation data selected for use by the system may be data for wish ground truth data is available to the system

At block 304, the output data generated by the model executed at the model service may be received and stored. In the example of FIG. 3, this output data will be referred to as “validation output data.” The validation output data may include the model-generated labels, categorizations, classification, etc. The validation output data may or may not include the input data and/or one or more references to the input data that may indicate an association with the input unstructured data and the model-generated labels, categorizations, classification, etc. The validation output data may be stored at a validation dataset or data store as described herein. The system may also generate a timestamp and/or other indication of a time of receipt of this first validation output data. Alternatively or additionally, the system may generate a timestamp and/or other indication of a time of transmission of the validation data that was provided to the model service to generate the first validation output data.

At block 306, the system may determine whether an output data accuracy determination condition has occurred or been detected. For example, the system may be configured to perform one or more model accuracy determinations periodically (e.g., hourly, daily, weekly, etc.). Alternatively or additionally, the system may be configured to perform one or more model accuracy determinations based on receiving an instruction from a user or other system. Alternatively or additionally, the system may be configured to perform one or more model accuracy determinations based on detecting one or more other systemic conditions, such as detecting a threshold amount of input data sent to a model service and/or detecting receipt of a threshold amount of output data from the model service. Any other conditions may be detected and evaluated at block 306.

If no output data accuracy determination condition is detected at block 306, the system may return to block 306 until such a condition is detected.

If, at block 306, an output data accuracy determination condition is detected, at block 308, the system may compare the validation output data to the ground truth data to determine if there are any differences. In examples, the system may determine if the labels, categorizations, classification, attributes, properties, etc. of the validation output data differ from the corresponding labels, categorizations, classification, attributes, properties, etc. of the ground truth data. For example, the system may determine how well labels associated with a piece of validation data (e.g., image, audio file, video file, document, etc.) correspond to the labels for that piece of validation data represented in the ground truth data. In examples, the system may determine a difference value or a discrepancy value that may represent the determined differences.

At block 310, the system may determine whether any determined discrepancies between the validation output data and the ground truth data are significant. In examples, the system may use a difference threshold to determine significance. In a particular non-limiting example, the system may be configured to use a 10% difference threshold. In such an example, if there are 100 audio files in which the word “accident” is recited (as indicated by labels in the ground truth data) and the validation output data properly labels 95 of those files with an “accident” label (e.g., 5% discrepancy value), the system may determine that this is not a significant discrepancy. However, if the validation output data only properly labels 75 of those files with an “accident” label (e.g., 25% discrepancy value), the system may determine that this is a significant discrepancy and may indicate that the model is overly inaccurate. As will be appreciated, any other thresholds and means of comparing two or more output datasets may be used and are contemplated as within the scope of the instant disclosure. Note that the system may store any determined differences or discrepancies (regardless of whether they reach a difference threshold) and associated data for other operations, such as trend determinations.

If there are no significant differences or discrepancies between the validation output data and the ground truth data determined at block 310, the system may return to block 306 for the next output data accuracy determination condition detection.

If there are significant differences or discrepancies between the validation output data and the ground truth data determined at block 310, at block 312, the system may initiate one or more actions based on the determined differences. Examples of such actions are described in more detail herein, including above in regard to FIG. 1 and below in regard to FIG. 6. The process may also then return to block 306 for the output data accuracy determination condition detection.

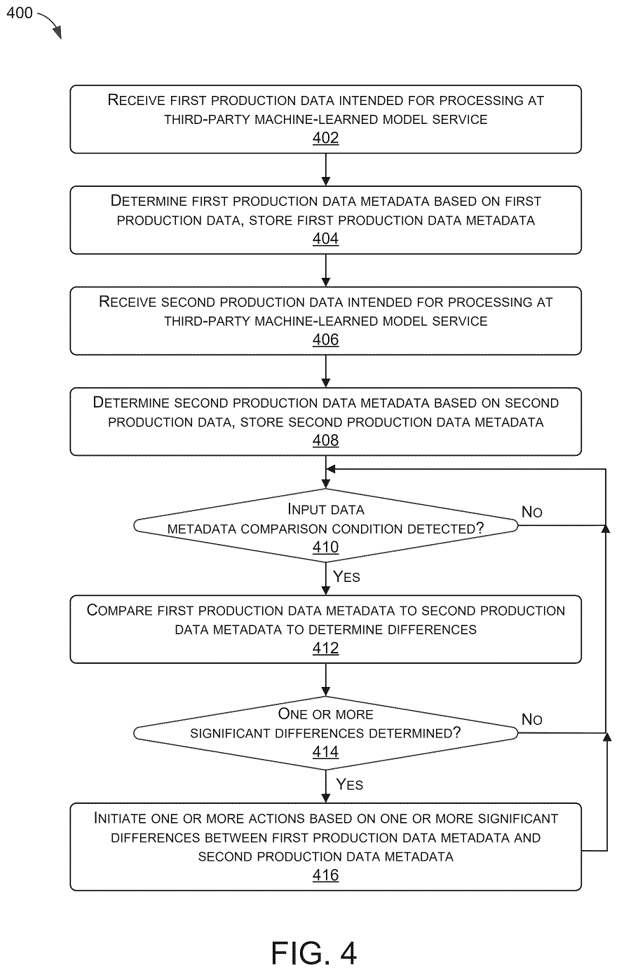

FIG. 4 is a flow diagram of an example process 400 for determining model and/or system metadata variability in an intelligent machine-learned model monitoring system. In examples, one or more operations of the process 400 may be implemented by a machine-learned model monitoring system, such as by using one or more of the components and systems illustrated in FIG. 1. In examples, one or more operations of the process 400 may be implemented by the machine-learned model monitoring system 140 illustrated in FIG. 1. One or more operations of the process 400 may also, or instead, be implemented by one or more of the components and systems associated with the computing device 700 illustrated in FIG. 7. In other examples, one or more operations of the process 400 may be performed by a combination of components described in regard to these systems and/or other systems. However, the process 400 is not limited to being performed by such components and systems, and the components and systems described herein are not limited to performing the operations of the process 400.

At block 402, the system may receive, at a first time, input data intended for use as input data to be provided to a model system. For example, the system may receive production unstructured data at the first time from a consumer system and a request to determine labels, categorizations, classification, etc., that indicate objects, features, and other content represented by such unstructured data. This production unstructured data received at the first time may be referred to in regard to the example of FIG. 4 as “first production data.”

At block 404, the system may determine metadata for the first production data. For example, the system may determine first production data metadata such as file type, file size, resolution, location (e.g., GPS coordinates), duration (e.g., length of an audio or video file), data capture device type and/or identifier. The system may also, or instead, determine system-generated metadata such as file source, file owner, file creator, associated business organization, etc.

At block 406, the system may receive, at a second time subsequent to the first time, further input data intended for use as input data to be provided to the model system. For example, the system may receive subsequent production unstructured data at the second time from a consumer system and a request to determine labels, categorizations, classification, etc., that indicate objects, features, and other content represented by such unstructured data. This subsequent production unstructured data received at the second time may be referred to in regard to the example of FIG. 4 as “second production data.”

At block 408, the system may determine metadata for the second production data in a similar manner as for the first production data.

At block 410, the system may determine whether an input data metadata comparison condition has occurred or been detected. For example, the system may be configured to perform one or more metadata comparisons periodically (e.g., hourly, daily, weekly, etc.). Alternatively or additionally, the system may be configured to perform one or more metadata comparisons based on receiving an instruction from a user or other system. Alternatively or additionally, the system may be configured to perform one or more metadata comparisons based on detecting one or more other systemic conditions, such as detecting a threshold amount of input data sent to a model service and/or detecting receipt of a threshold amount of output data from the model service. Any other conditions may be detected and evaluated at block 410.

If no input data metadata comparison condition is detected at block 410, the system may return to block 410 until such a condition is detected.

If, at block 410, an input data metadata comparison condition is detected, at block 412, the system may compare the metadata for the first production data to the metadata for the second production data to determine if there are any differences. In examples, the system may determine if the type and amounts of metadata differ. For example, the system may determine a percentage of images of a particular format or resolution are represented in each dataset. In examples, the system may determine a difference value or a discrepancy value that may represent the determined differences.

At block 414, the system may determine whether any determined differences between the metadata for the first production data and the metadata for the second production data are significant. In examples, the system may use a difference threshold to determine significance. In a particular non-limiting example, the system may be configured to use a 25% difference threshold. In such an example, if there are 100 images of a particular high resolution (as indicated by the associated metadata) in the first production data and there are 85 images of the particular high resolution (as indicated by the associated metadata) in the second production data (e.g., 15% difference value), the system may determine that this is not a significant difference. However, if there are 100 images of a particular high resolution (as indicated by the associated metadata) in the first production data and there are 25 images of the particular high resolution (as indicated by the associated metadata) in the second production data (e.g., 75% difference value), the system may determine that this is a significant difference. As will be appreciated, any other thresholds and means of comparing the metadata of two or more input datasets may be used and are contemplated as within the scope of the instant disclosure. Note that the system may store any determined differences or discrepancies (regardless of whether they reach a difference threshold) and associated data for other operations, such as trend determinations.

If there are no significant differences or discrepancies between the metadata for the first production data and the metadata for the second production data determined at block 414, the system may return to block 410 for the next output data accuracy determination condition detection.

If there are significant differences or discrepancies between the metadata for the first production data and the metadata for the second production data determined at block 414, at block 416, the system may initiate one or more actions based on the determined differences. Examples of such actions are described in more detail herein, including above in regard to FIG. 1 and below in regard to FIG. 6. The process 400 may also then return to block 410 for the next input data metadata comparison condition detection.

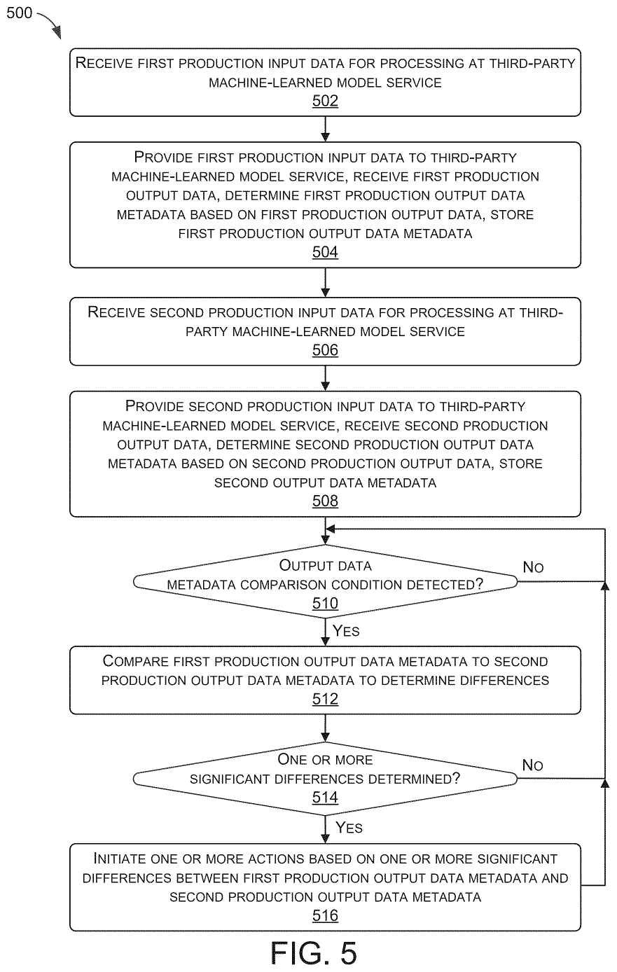

FIG. 5 is a flow diagram of an example process 500 for determining model and/or system metadata variability in an intelligent machine-learned model monitoring system. In examples, one or more operations of the process 500 may be implemented by a machine-learned model monitoring system, such as by using one or more of the components and systems illustrated in FIG. 1. In examples, one or more operations of the process 500 may be implemented by the machine-learned model monitoring system 140 illustrated in FIG. 1. One or more operations of the process 500 may also, or instead, be implemented by one or more of the components and systems associated with the computing device 700 illustrated in FIG. 7. In other examples, one or more operations of the process 500 may be performed by a combination of components described in regard to these systems and/or other systems. However, the process 500 is not limited to being performed by such components and systems, and the components and systems described herein are not limited to performing the operations of the process 500.

At block 502, the system may receive, at a first time, input data intended for use as input data to be provided to a model system. For example, the system may receive production unstructured data at the first time from a consumer system and a request to determine labels, categorizations, classification, etc. that indicate objects, features, and other content represented by such unstructured data. This production unstructured data received at the first time may be referred to in regard to the example of FIG. 5 as “first production input data.”

At block 504, the system may provide the first production input data to a machine-learned model service with a request for output data generation. For example, unstructured input data (e.g., images, video, audio, documents, etc.) may be sent to a cloud-based service provider that executes a machine-learned model to determine output indicating labels, categorizations, classification, etc., that may identify objects, features, and/or other content represented by such unstructured data. The unstructured first production input data may be provided with instructions requesting particular output, such as labels, categorizations, classification, etc. The unstructured data and request instructions may be provided to the service provider via an API configured at the model service.

Further at block 504, the output data generated by the model executed at the model service may be received and stored. In example of FIG. 5, this output data will be referred to as “first production output data.” This first production output data may include any of the model-generated data described herein as well as associated metadata. In some examples, the metadata from the first production input data may be replicated in the first production output data. In other examples, the model and/or the model service may update, supplement, remove, and/or add metadata to the first production output data. The metadata of the first production output data may be stored at a dataset or data store as described herein. The system may also generate a timestamp and/or other indication of a time of receipt of the metadata of the first production output data. Alternatively or additionally, the system may generate a timestamp and/or other indication of a time of transmission of the first production input data that was provided to the model service to generate the metadata of the first production output data.

At block 506, the system may receive, at a second time subsequent to the first time, input data intended for use as input data to be provided to a model system. For example, the system may receive production unstructured data at the second time from a consumer system and a request to determine labels, categorizations, classification, etc. that indicate objects, features, and other content represented by such unstructured data. This subsequent production unstructured data received at the second time may be referred to in regard to the example of FIG. 5 as “second production input data.”

At block 508, the system may provide the second production input data to a machine-learned model service with a request for output data generation in a similar manner as performed for the first production input data. Further at block 508, the output data generated by the model executed at the model service may be received and stored, in this case, referred to as “second production output data.” This second production output data may include any of the model-generated data described herein as well as associated metadata that may be the same as that of the second production input data and/or modified (e.g., by the model or model service). The metadata of the second production output data may also be stored at a dataset or data store as described herein, along with an appropriate time stamp.

At block 510, the system may determine whether an output data metadata comparison condition has occurred or been detected. For example, the system may be configured to perform one or more metadata comparisons periodically (e.g., hourly, daily, weekly, etc.). Alternatively or additionally, the system may be configured to perform one or more metadata comparisons based on receiving an instruction from a user or other system. Alternatively or additionally, the system may be configured to perform one or more metadata comparisons based on detecting one or more other systemic conditions, such as detecting a threshold amount of input data sent to a model service and/or detecting receipt of a threshold amount of output data from the model service. Any other conditions may be detected and evaluated at block 410.

If no output data metadata comparison condition is detected at block 510, the system may return to block 510 until such a condition is detected.

If, at block 510, an output data metadata comparison condition is detected, at block 512, the system may compare the metadata for the first production output data to the metadata for the second production output data to determine if there are any differences. In examples, the system may determine if the type and amounts of metadata differ. For example, the system may determine a percentage of audio files of a particular audio resolution are represented in each dataset. In examples, the system may determine a difference value or a discrepancy value that may represent the determined differences.

At block 514, the system may determine whether any determined differences between the metadata for the first production output data and the metadata for the second production output data are significant. In examples, the system may use a difference threshold to determine significance. In a particular non-limiting example, the system may be configured to use a 50% difference threshold. In such an example, if there are 100 documents of a relatively small size (e.g., <25 KB) (as indicated by the associated metadata) in the first production output data and there are 75 documents of a similar relatively small size (as indicated by the associated metadata) in the second production output data (e.g., 25% difference value), the system may determine that this is not a significant difference. However, 100 documents of a relatively small size (e.g., <25 KB) (as indicated by the associated metadata) in the first production output data, and there are 15 documents of a similar relatively small size (as indicated by the associated metadata) in the second production data (e.g., 85% difference value), the system may determine that this is a significant difference. As will be appreciated, any other thresholds and means of comparing the metadata of two or more output datasets may be used and are contemplated as within the scope of the instant disclosure. Note that the system may store any determined differences or discrepancies (regardless of whether they reach a difference threshold) and associated data for other operations, such as trend determinations.

If there are no significant differences or discrepancies between the metadata for the first production output data and the metadata for the second production output data determined at block 514, the system may return to block 510 for the next output data metadata comparison condition detection.

If there are significant differences or discrepancies between the metadata for the first production output data and the metadata for the second production output data determined at block 514, at block 516, the system may initiate one or more actions based on the determined differences. Examples of such actions are described in more detail herein, including above in regard to FIG. 1 and below in regard to FIG. 6. The process 500 may also then return to block 510 for the next output data metadata comparison condition detection

FIG. 6 is a flow diagram of an example process 600 for determining one or more actions responsive to model and related data accuracy and/or variability determinations in an intelligent machine-learned model monitoring system. In examples, one or more operations of the process 600 may be implemented by a machine-learned model monitoring system, such as by using one or more of the components and systems illustrated in FIG. 1. In examples, one or more operations of the process 600 may be implemented by the machine-learned model monitoring system 140 illustrated in FIG. 1. One or more operations of the process 600 may also, or instead, by implemented by one or more of the components and systems associated with the computing device 700 illustrated in FIG. 7. In other examples, one or more operations of the process 600 may be performed by a combination of components described in regard to these systems and/or other systems. However, the process 600 is not limited to being performed by such components and systems, and the components and systems described herein are not limited to performing the operations of the process 600.

At block 602, the system may receive or generate model monitoring data that may indicate that a significant discrepancy, difference, or inaccuracy has been determined (e.g., as described herein). Alternatively or additionally, the system may simply receive model monitoring data at block 602 and responsibly take one or more of the disclosed actions based on that data, regardless of whether the data is associated with a significant discrepancy, difference, or inaccuracy.

At block 604, the system may determine the one or more responsive actions to implement in response to the data received at block 602. In examples, different types and/or severities of model monitoring data may trigger different responsive actions. For instance, a detected model inaccuracy may trigger a different response than a detected discrepancy in metadata. Likewise, a relatively minor model output variability may trigger a different response than a major model output variability. Various techniques may be used to determine the appropriate one or more responses and are contemplated as within the scope of the instant disclosure.

In examples, a responsive action may include generating a user notification of model monitoring results at block 606. This may include generating a communication of some type, such as an email, a voice message, a text message, a popup window, a vibrating notification, or haptic feedback on a user computing device, etc. The responsive actions of block 606 may also, or instead, include updating an interface, such as a model monitoring dashboard interface, with current model monitoring data based on the data received at block 602. This may further include determining a trend for a particular determination type based on the data received at block 602 and historical data for that determination type (e.g., the historical accuracy of a model over a period of time as determined based on validation data and associated ground truth data). The process 600 may return to block 602 to process subsequent model monitoring data after implementing the operations of block 606.

In examples, a responsive action may include determining whether to replace the current model in use with another model. At block 608, the system may compare the accuracy and/or variation of the model (or model service) indicated in the model monitoring data received at block 602 with accuracy and/or variation data for one or more other available models (or model services). For example, the system may routinely determine and track variability and/or accuracy of multiple models that may be trained or otherwise capable of performing similar functions. At block 608, the system may compare one or more accuracy or variability metrics associated with such models to determine if there are any significant differences.

At block 610, the system may determine whether such differences are present and, in examples, if they are sufficiently significant (e.g., based on a threshold) to warrant a model change. If there are no differences or no sufficiently significant differences in model performance as measured by the accuracy and/or variability determinations described herein, at block 614, the system may retain the same model (or model service) and continue to use it, returning to block 602 to process subsequent model monitoring data.

If, at block 610, the system determines that there are differences or sufficiently significant differences in model performance as measured by the accuracy and/or variability determinations described herein, at block 612, the system may determine a replacement model or model service, for example, by determining the most accurate or least variable as measured using the disclosed determinations. The system may then instruct the model service to utilize the selected model going forward. Alternatively or additionally, the system may instruct upstream consumer systems that request model processing to request the selected higher-performing model. Alternatively or additionally, the system may perform a configuration change (e.g., at the system) to ensure that model processing is directed to the selected higher-performing model. Any other appropriate actions to redirect model processing requests to the selected higher-performing model may be implemented at block 612. The process may then return to block 602 to process subsequent model monitoring data.

In examples, a responsive action may include training or retraining one or more downstream models. At block 616, the system may determine appropriate training operations for a downstream model (e.g., operated or executed by a downstream consumer system) that may adjust that model to perform better based on the model monitoring data received at block 602. For example, if the system determines a significant change in metadata of received input data (e.g., a different file format or file size has recently become much more prevalent in input datasets), the system may determine one or more operations that may cause one or more downstream models to be retrained using training data associated with the changed metadata (e.g., training data having the new, different file format or file size). This may entail sending instructions to the consumer system operating such models, notifying one or more administrators to perform such retraining, and/or automatically initializing such training, for example, using the collected input data with the changed metadata as training data.

At block 618, this downstream model training may be implemented. The process 600 may return to block 602 to process subsequent model monitoring data after implementing the operations of block 606.

FIG. 7 shows an example system architecture for a computing device 700 that may be implemented as (e.g., part of) any of the systems and devices described herein and/or may perform any of the operations and processes described herein. For example, the computing device 700 may represent any of the systems, devices, and components illustrated in FIG. 1. The computing device 700 may also represent any system configured to implement any of the functions and operations described in regard to FIGS. 2-6 and/or any other operation described herein. The computing device 700 may also represent any system configured to generate any of the interfaces described in regard to FIG. 1 and/or any other interfaces described herein. The computing device 700 may be a server, computer, mobile device (e.g., smartphone, smartwatch, laptop), or any other type of computing device that may execute any of the operations described herein. In some examples, operations as described herein may be distributed among and/or executed by multiple computing devices 700.

A computing device 700 can include memory 702. In various examples, the memory 702 can include system memory, which may be volatile (such as RAM), non-volatile (such as ROM, flash memory, etc.), or some combination of the two. The memory 702 may further include non-transitory computer-readable media, such as volatile and nonvolatile, removable and non-removable media implemented in any method or technology for storage of information, such as computer-readable instructions, data structures, program modules, or other data. System memory, removable storage, and non-removable storage are all examples of non-transitory computer-readable media.

Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by one or more computing devices 700. Any such non-transitory computer-readable media may be part of the computing devices 700.

The memory 702 may include modules and data 704 needed to perform operations as described herein by one or more computing devices 700. Included with such modules and data 704 and/or also stored in the memory 702 may be one or more model input data determination components 720, one or more metadata analysis components 722, one or more dataset analysis components 724, one or more dashboard generation components 726, and/or one or more model output data determination components 728.

The model input data determination component(s) 720 may perform any one or more of the operations related to determining, obtaining, accessing, and/or processing model and/or service input data as described herein (e.g., as described for model input data determination component 142 illustrated in FIG. 1). The model output data determination component(s) 728 may perform any one or more of the operations related to determining, obtaining, accessing, and/or processing model and/or service output data as described herein (e.g., as described for model output data determination component 148 illustrated in FIG. 1). The metadata analysis component(s) 722 may perform any one or more of the operations related to metadata analysis, including variability determination, as described herein (e.g., as described for metadata analysis component 144 illustrated in FIG. 1). The dataset analysis component(s) 724 may perform any one or more of the operations related to dataset analysis, including variability and accuracy determination, as described herein (e.g., as described for dataset analysis component 146 illustrated in FIG. 1). The dashboard generation component(s) 728 may perform any one or more of the operations related to generating, transmitting and/or providing data and/or instructions for one or more model monitoring dashboard interfaces or any other interface described herein (e.g., as described for dashboard generation component 149 illustrated in FIG. 1).

The modules and data 704 may further include and/or facilitate access to validation data 703 (e.g., that may be any data as described for validation dataset 141 illustrated in FIG. 1), ground truth data 705 (e.g., that may be any data as described for ground truth dataset 143 illustrated in FIG. 1), production data 707 (e.g., that may be any data as described for production dataset 145 illustrated in FIG. 1), and/or metadata data 709 (e.g., that may be any data as described for historical metadata dataset 147 illustrated in FIG. 1).

One or more computing devices 700 may also have processor(s) 706, communication interface(s) 708, display(s) 710, output device(s) 712, input device(s) 714, and/or drive unit(s) 716 that may include one or more machine-readable media 718.

In various examples, the processor(s) 706 can be a central processing unit (CPU), a graphics processing unit (GPU), both a CPU and a GPU, or any other type of processing unit. Each of the one or more processor(s) 706 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 706 may also be responsible for executing computer applications stored in the memory 702, which can be associated with common types of volatile (RAM) and/or nonvolatile (ROM) memory.

The communication interfaces 708 may include transceivers, modems, interfaces, antennas, telephone connections, and/or other components that can transmit and/or receive data over wired and/or wireless networks, telephone lines, and/or other connections.

The display(s) 710 can be any one or more of a liquid crystal display or any other type of display commonly used in computing devices. For example, the display(s) 710 may include a touch-sensitive display screen that may also act as an input device or keypad, such as for providing a soft-key keyboard, navigation buttons, and/or any other type of input.

The output device(s) 712 may include any sort of output devices known in the art, such as the display(s) 710, one or more speakers, a vibrating mechanism, a haptic feedback device, and/or a tactile feedback mechanism. Output devices 712 may also include one or more ports for one or more peripheral devices, such as headphones, peripheral speakers, and/or a peripheral display.

The input device(s) 714 may include any sort of input devices known in the art. For example, input device(s) 714 may include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine-readable media 718 of drive unit(s) 716 may store one or more sets of instructions, such as software or firmware, that embodies any one or more of the methodologies or functions described herein. The instructions can also reside, completely or at least partially, within the memory 702, processor(s) 706, and/or communication interface(s) 708 during execution thereof by the one or more computing devices 700. The memory 702 and the processor(s) 706 may also constitute machine-readable media 718.

With the techniques described herein, data received via, or otherwise associated with multiple communications channels may be more accurately associated with a particular context and more efficiently stored and provided for processing using an interaction interface. Furthermore, the communications channels may be changed while maintaining communications consistency with a user, thereby improving user satisfaction and increasing the efficiency of data collection and processing.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computer-implemented method for inferring obscured data processing system performance, the computer-implemented method comprising:
transmitting, by a processor at a first time, first unstructured input data to an obscured data processing system;
receiving, at the processor from the obscured data processing system, first labeled output data associated with the first unstructured input data;
transmitting, by the processor at a second time subsequent to the first time, the first unstructured input data to the obscured data processing system;
receiving, at the processor from the obscured data processing system, second labeled output data associated with the first unstructured input data;
determining, at the processor, based on first labels represented in the first labeled output data and second labels represented in the second labeled output data, a difference value indicating a difference between the first labeled output data and the second labeled output data;
determining, at the processor, that the difference value meets or exceeds a difference threshold; and
initiating, at the processor, based on determining that the difference value meets or exceeds a difference threshold, a reconfiguration of a computing system configured to consume output generated by the obscured data processing system.

2. The computer-implemented method of claim 1, further comprising transmitting, based on the difference between the first labeled output data and the second labeled output data, to the computing system, one or more instructions to train a downstream data processing system configured to consume the output generated by the obscured data processing system.

3. The computer-implemented method of claim 1, further comprising generating an interface on a user computing device comprising a display element indicating the difference value.

4. The computer-implemented method of claim 1, further comprising transmitting one or more instructions to the computing system configured to consume output generated by the obscured data processing system to terminate processing of production data using the obscured data processing system.

5. The computer-implemented method of claim 1, wherein the difference value is a first difference value, the obscured data processing system is a first obscured data processing system, and wherein the computer-implemented method further comprises:
determining a second difference value for a second obscured data processing system;
determining that the first difference value is less than or equal to the second difference value; and
in response to determining that the first difference value is less than or equal to the second difference value, processing production data using the first obscured data processing system.

6. The computer-implemented method of claim 1, wherein the difference value is a first difference value, the obscured data processing system is a first obscured data processing system, and wherein the computer-implemented method further comprises:
determining a second difference value for a second obscured data processing system;
determining that the first difference value is greater than the second difference value; and
in response to determining that the first difference value is greater than the second difference value:
terminating processing of production data using the second obscured processing system; and
initiating processing of the production data using the second obscured data processing system.

7. A non-transitory computer-readable medium comprising instructions that, when executed by one or more processors, cause the one or more processors to infer third-party machine-learned model performance by performing operations comprising:
transmitting first unstructured input data to a third-party machine-learned model;
receiving, from the third-party machine-learned model, first labeled output data associated with the first unstructured input data;
determining, based on first labels represented in the first labeled output data and second labels represented in ground truth data associated with the first unstructured input data, a difference value indicating a difference between the first labeled output data and the ground truth data;
determining that the difference value meets or exceeds a difference threshold; and
initiating, based on determining that the difference value meets or exceeds a difference threshold, one or more responsive actions.

8. The non-transitory computer-readable medium of claim 7, wherein the difference value is a first difference value, the third-party machine-learned model is a first third-party machine-learned model, and the one or more responsive actions comprise:
determining a second difference value for a second third-party machine-learned model;
determining that the second difference value is less than the first difference value; and
in response to determining that the second difference value is less than the first difference value:
terminating processing of production data using the second third-party machine-learned model; and
initiating processing of the production data using the second third-party machine-learned model.

9. The non-transitory computer-readable medium of claim 7, wherein the one or more responsive actions comprise generating an interface on a user computing device comprising a display element indicating the difference value.

10. The non-transitory computer-readable medium of claim 7, wherein the one or more responsive actions comprise activating one or more of a haptic feedback device or vibrating mechanism as a user computing device.

11. The non-transitory computer-readable medium of claim 7, wherein the one or more responsive actions comprise transmitting one or more instructions to a computing system configured to consume output generated by the third-party machine-learned model to terminate processing of production data using the third-party machine-learned model.

12. The non-transitory computer-readable medium of claim 7, wherein the difference value is a first difference value, the third-party machine-learned model is a first third-party machine-learned model, and the one or more responsive actions comprise:
determining a second difference value for a second third-party machine-learned model;
determining that the first difference value is less than or equal to the second difference value; and
in response to determining that the first difference value is less than or equal to the second difference value, processing production data using the first third-party machine-learned model.

13. The non-transitory computer-readable medium of claim 7, wherein the one or more responsive actions comprise at least one of:
transmitting an email notification comprising the difference value,
transmitting a text message notification comprising the difference value, or
transmitting a voice message notification comprising the difference value.

14. The non-transitory computer-readable medium of claim 7, wherein the one or more responsive actions comprise transmitting one or more instructions to train, based on the difference between the first labeled output data and the ground truth data, a downstream machine-learned model configured to consume output generated by the third-party machine-learned model.

15. A system for inferring third-party machine-learned model performance, the system comprising:
one or more processors; and
a non-transitory memory storing computer-executable instructions that, when executed, cause the one or more processors to perform operations comprising:
determining first metadata for first unstructured input data received, at a first time, for processing at a third-party machine-learned model;
determining second metadata for second unstructured input data received, at a second time subsequent to the first time, for processing at the third-party machine-learned model;
determining, based on first metadata and the second metadata, a difference value indicating a difference between the first metadata and the second metadata;
determining that the difference value meets or exceeds a difference threshold; and
initiating, based on determining that the difference value meets or exceeds a difference threshold, one or more responsive actions.

16. The system of claim 15, wherein the one or more responsive actions comprise transmitting one or more instructions to train, based on the difference between the first metadata and the second metadata, a downstream machine-learned model configured to consume output generated by the third-party machine-learned model.

17. The system of claim 15, wherein the one or more responsive actions comprise at least one of:
transmitting an email notification comprising the difference value,
transmitting a text message notification comprising the difference value, or
transmitting a voice message notification comprising the difference value.

18. The system of claim 15, wherein the difference between the first metadata and the second metadata comprises a difference of one or more of file resolution, file type, file size, or location.

19. The system of claim 15, wherein the one or more responsive actions comprise generating an interface on a user computing device comprising a display element indicating the difference value.

20. A system for inferring third-party machine-learned model performance, the system comprising:
means for transmitting first unstructured input data to a third-party machine-learned model;
means for receiving, from the third-party machine-learned model, first labeled output data associated with the first unstructured input data;
means for determining, based on first labels represented in the first labeled output data and second labels represented in ground truth data associated with the first unstructured input data, a difference value indicating a difference between the first labeled output data and the ground truth data;
means for determining that the difference value meets or exceeds a difference threshold; and
means for initiating, based on determining that the difference value meets or exceeds a difference threshold, one or more responsive actions.
